(19) United States
(12) Patent Application Publication
(10) Pub. No.: US 2008/0122791 A1
(43) Pub. Date: May 29, 2008

(54) Multi-function optical mouse

(76) Inventor: Wei Hsu, Taipei County (TW)

Correspondence Address: WEI HSU, P.O. Box 44 - 2049, Taipei, 10668, omitted

(21) Appl. No.: 11/603,829

(22) Filed: Nov. 24, 2006

(51) Int. Cl. G06F 3/033

(52) U.S. Cl. 345/165

(57) ABSTRACT

The invention relates to a multi-function optical mouse, which integrates various functions of computer peripheral apparatuses onto a mouse body. The feature lies in that a mouse control device in an original optical mouse is combined with a video/audio device and a mass storage device in conjunction with multiple units outside the mouse and a multi-memory card socket. Thus, the multi-function optical mouse having the audio playing and storing function, the personal file access function, and the IP phone connection function is achieved.

### BACKGROUND OF THE INVENTION

(1) Field of the Invention

The invention relates to an improved design of a mouse structure, and more particularly to a multi-function optical mouse, which has the integrated function of multiple computer peripherals to diversify the usage.

(2) Description of the Prior Art

A computer mouse is one of the indispensable peripherals for controlling a computer. The conventional roller-type mouse, track ball type mouse or touch pad sensitive type mouse is not better than the optical mouse because the pure optical mouse works without friction and is free from the problem that the accumulated contamination jams the rolling mechanism. In addition, the optical mouse has more display points, and the moving distance thereof may be easily controlled. Thus, it is estimated that no product, which may replace the optical mouse, is available in a few years.

However, the optical mouse or any other type of mouse still has drawbacks. Because the mouse is widely used, it is a little wasteful if the mouse, which meets the human engineering design and has the structural pattern with the suitable hand-held size, only provides the function of changing the visual screen. Although the miniaturized mouse has become the basis of designing the mouse structure, it has the drawback of poor hand-held feeling. Also, there are many kinds of peripheral apparatuses for the personal computer, and a relative large number of peripheral apparatuses are frequently used. Thus, the user often has to swap the apparatuses and thus feels complicated and inconvenient. More particularly, when the personal computer is disposed under the table, the user has to inconveniently lean and tumble under the table to perform the frequent swapping operations.

In view of the drawbacks of the mouse structure and function, the present invention wants to provide a multi-function optical mouse having more than multiple computer peripheral functions integrated on a mouse body by way of continuous researching and testing according to the rich experiments and professional knowledge for seeking the solution. Thus, the user may easily control the peripherals to achieve the functions of audio playing and storing, personal file accessing, IP phone connecting, and the like.

### SUMMARY OF THE INVENTION

It is therefore an object of the invention to provide a multi-function optical mouse, which has the integrated functions of various computer peripheral apparatuses, such as a card reader, a IP phone, a telephone recorder, an audio player, and an apparatus for conference call, has the convenient and high effectiveness, manages the peripheral apparatuses more effectively, and decreases the possibility of forgetting to carry the essential parts.

To achieve the above-identified object, the invention provides a multi-function optical mouse having the high convenience and mobility in use and thus the enhanced additional value. The multi-function optical mouse has an internal mouse control device combining a video/audio device and a mass storage device together, and an exterior, on which a display, a button control, a select switch, a phone jack, a mic-phone jack, a speaker, a mic-phone and a multi-memory card socket are disposed. Thus, the multi-function optical mouse has the integrated functions of audio playing, audio storing, personal file accessing and IP phone connecting.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a block diagram showing a mouse circuit according to a preferred embodiment of the invention.

FIG. 2 is one pictorial view showing a mouse according to the preferred embodiment of the invention.

FIG. 3 is another pictorial view showing the mouse according to the preferred embodiment of the invention.

FIG. 4 is still another pictorial view showing the mouse according to the preferred embodiment of the invention.

### DETAILED DESCRIPTION OF THE PREFERRED EMBODIMENTS

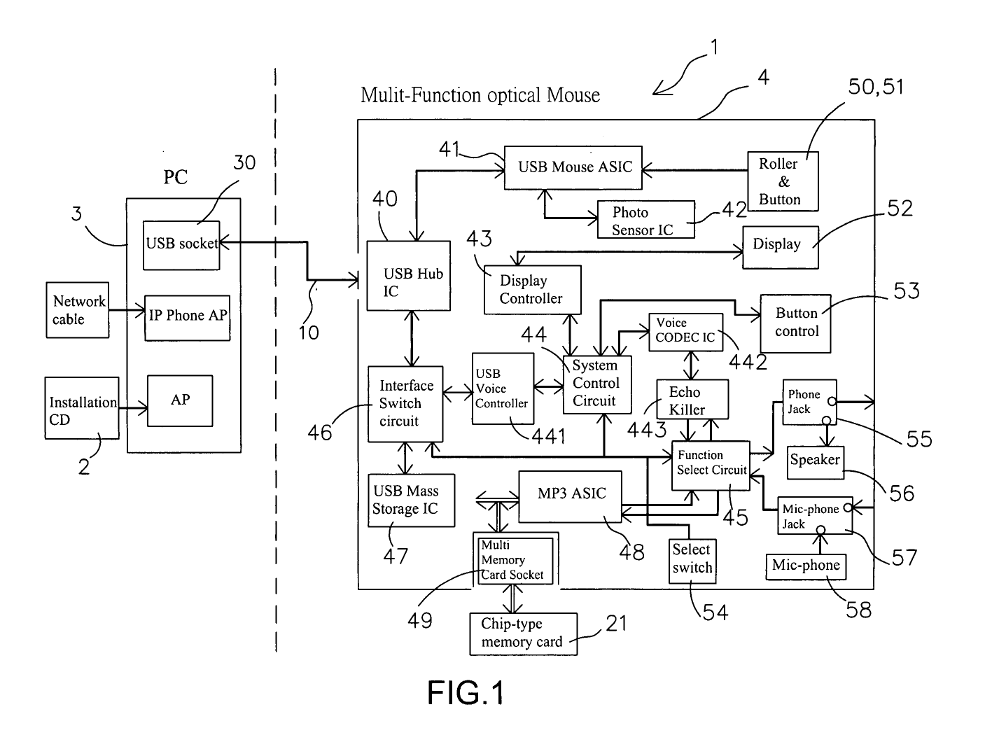

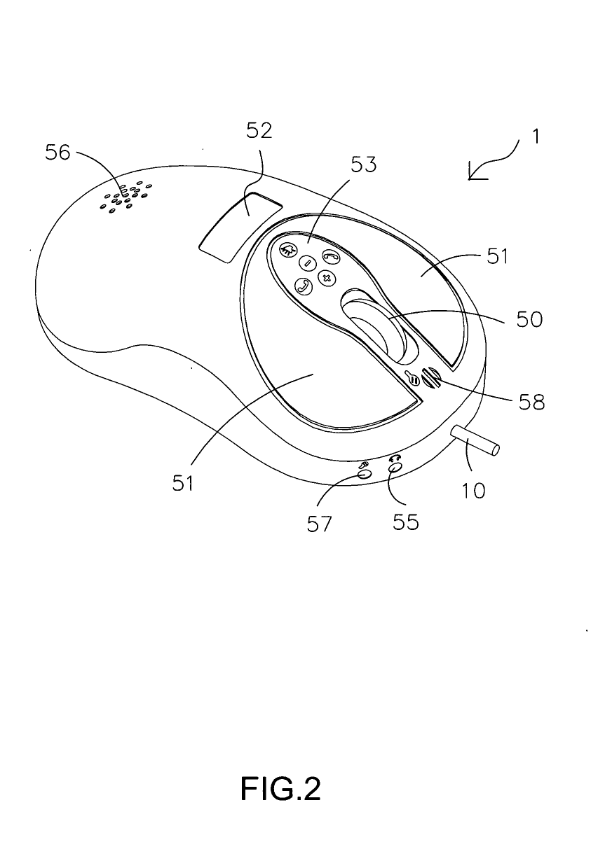

As shown in FIGS. 1 and 2, a multi-function optical mouse (1) according to a preferred embodiment of the invention has an exterior structure, which comprises a mouse roller (50) and buttons (51) corresponding to those of the prior art. Because the mouse roller (50) and the buttons (51) pertain to the basic structure of the typical mouse and have nothing to do with the key point of the invention, detailed descriptions thereof will be omitted.

As shown in FIG. 1, the multi-function optical mouse (1) according to the preferred embodiment of the invention is composed of an internal multi-layer printed circuit (4), which is connected to a personal computer (3). The mouse also has external attachments.

The external attachments include an installation CD (2), which contains an application program capable of communicating with an IP phone driver, and a chip-type memory card (21) with the frequently available specifications. The chip-type memory card (21) may be a CF memory card, a SD memory card, a MMC memory card, a RS-MMC memory card, a MS-Pro memory card, a MS-Duo memory card or a MiniSD memory card.

The multi-function optical mouse (1) of the invention is also connected to a USB socket (30) of the personal computer (3) through a USB cable (10).

The feature of the invention is that the internal structure of the multi-function optical mouse (1) is composed of the multi-layer printed circuit (4). In this embodiment, the multi-layer printed circuit (4) includes a USB (Universal Serial Bus) hub IC (Integrated circuit) (40), a USB mouse ASIC (Application Specific Integrated Circuit) (41), a photo sensor IC (42), a roller & button (50, 51), a display controller (43), a display (52), a system control circuit (44), a USB voice controller (441), a voice CODEC IC (442), a button control (53), an echo killer (443), a function select circuit (45), a select switch (54), a phone jack (55), a speaker (56), a mic-phone jack (57), a mic-phone (58), an interface switch circuit (46), a USB mass storage IC (47), a MP3 ASIC (48) and a multi-memory card socket (49).

As shown in FIG. 2, the multi-function optical mouse (1) has a mouse roller (50) and two buttons (51) disposed at two sides of the mouse roller (50). The mouse roller (50) and the buttons (51) are disposed on a front half surface of the exterior structure. The mic-phone (58) is disposed in front of the mouse roller (50). The button control (53) is disposed in back of the mouse roller (50). The display (52) is disposed on a middle of the surface. The speaker (56) is disposed near a rear half of the surface. The phone jack (55) and the mic-phone jack (57) are disposed a lateral side of the front of the multi-function optical mouse (1). Also, the button control (53) further includes an answer button, a hang-up button, a volume-up button, a volume-down button and a mute button for the phone.

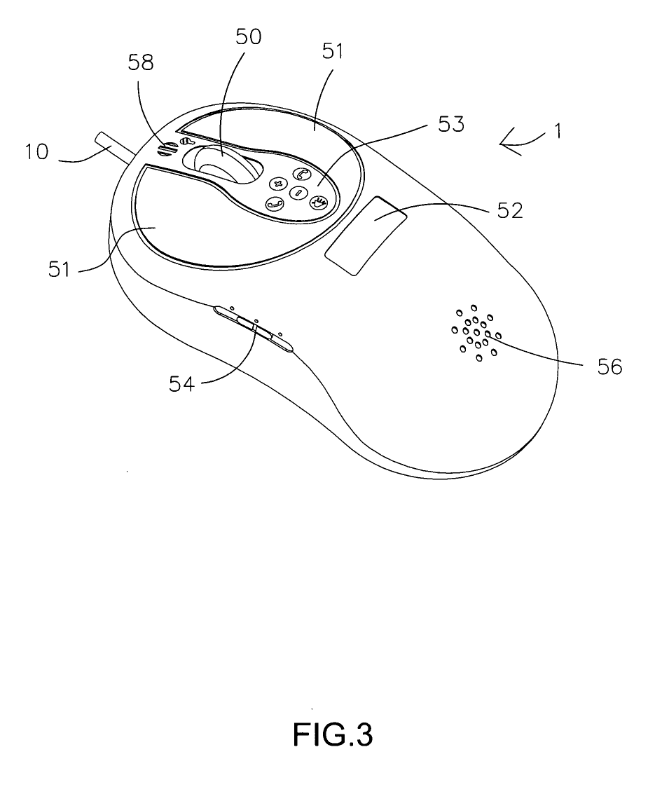

As shown in FIG. 3, the select switch (54) is disposed on the other lateral side of the surface of the multi-function optical mouse (1). Furthermore, a switch for switching among the functions of audio playing, audio storing and personal file accessing function alternately, and an audio recording button may be included.

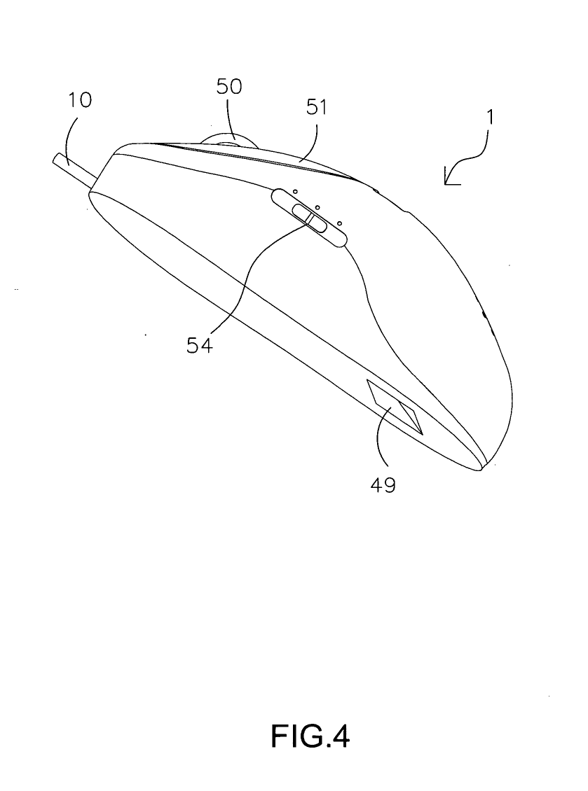

As shown in FIG. 4, the multi-memory card socket (49) is disposed on a rear half of the bottom surface of the multi-function optical mouse (1).

In the actual installation, after the multi-function optical mouse (1) is connected to the USB socket (30) of the personal computer (3) through the USB cable (10), the personal computer (3) recognizes the mouse function and automatically loads its build-in driver to control the cursor on the screen.

The principle of the invention will be described in the following. The USB hub IC (40) for integrating three functional devices including the controlling device of the original mouse, the video/audio device and the storage device is provided. In addition, the system control circuit (44) controls the overall coordinating operations, such as the displayed contents of the display (52), the operation of scanning whether all buttons are triggered, whether the loop is opened or closed, and the communication between the IP phone application program and the multi-function optical mouse. The operation will be described in the following. When the multi-function optical mouse (1) is moved, the photo sensor IC (42) in the multi-layer printed circuit (4) transfers the signals, which correspond to the displacement variation and direction and whether the mechanical devices such as the mouse roller (50) and the buttons (51) are triggered, to the USB interface. The USB mouse ASIC (41) encodes the signals into a data string, which meets the USB communication specification, to the personal computer (3) through the USB cable (10), and the cursor on the screen correctly responds with the data string.

According to the above-mentioned multi-function optical mouse (1) in actual use, as shown in FIG. 2, if the IP phone function has to be used to communicate with an online friend or customer, the user may directly operate the phone answer button or the hang-up button on the button control (53). During the communication, the voice of the other side is outputted from the speaker (56), and the response voice of the user's side is inputted through the mic-phone (58). Because the feedback result may generate the howl, the echo killer (443) can kill the howl. If the user does not want the dialog contents to interfere with others or the dialog contents contain the privacy, the phone jack (55) and the mic-phone jack (57) have to combine with a blower earphone set and a typical blower so as to output the voice from the earphone. During the communication process, the volume-up button and the volume-down button may also be momentarily operated to adjust the volume so that the good and proper communication quality may be obtained. The mute button may also be operated in special conditions to switch to the mute state to facilitate the usage.

Also, in the above-mentioned IP phone function, when the communication is being proceeded, as shown in FIG. 3, the select switch (54) disposed on the lateral side of the multi-function optical mouse (1) may be utilized to record the talking contents so that the report can be easily made or the evidence can be kept. The voice recording function may be used in conjunction with the personal file access function, as shown in FIG. 4. The compatible mass storage chip-type memory card (21) may be inserted into the multi-memory card socket (49) on the bottom of the multi-function optical mouse (1) so that the recording time can be lengthened.

When the chip-type memory card (21) storing the MP3 songs is inserted into the multi-function optical mouse (1), the music playing function may be switched through the function of the select switch (54), and the played music content information and condition may be obtained through the display (52).

Also, when the data access function of the multi-function optical mouse (1) is performed, the chip-type memory card (21) compatible with the specification of the multi-memory card socket (49) has to be inserted first. Meanwhile, the select switch (54) is operated such that the interface switch circuit (46) in the multi-layer printed circuit (4) is coupled to the USB hub IC (40) and to the personal computer (3). At this time, the personal computer (3) classifies the circuit into a mass storage device, calls a suitable driver therein, and controls the personal computer (3) to output the file data to the chip-type memory card (21) of the multi-function optical mouse (1) for storage, or the file data in the multi-function optical mouse (1) may be read.

According to the above-mentioned components and description, only operating the select switch (54) of the invention can perform the IP phone function or hands-free IP phone conference function, the function of recording the network dialog contents, the file access function and the audio playing and storing function. So, the effectiveness in use may be enhanced.

As mentioned hereinabove, the multi-function optical mouse of the invention integrates the frequently used computer peripheral functions onto the mouse structure such that the various computer peripheral apparatuses may be easily handled. In addition, it is possible to reduce the possibility of forgetting to carry the essential parts, and to greatly enhance the convenience and mobility of using the mouse. So, the mouse of the invention has the extremely high industrial value. In view of the technology and function of the invention, which exceeds the range of the prior art products and has the utility, and no publication data or reference can be found, the invention is disclosed in this application.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A multi-function optical mouse composed of a roller & button and a select switch disposed on an exterior of the mouse and a multi-layer printed circuit disposed in the mouse, wherein the multi-layer printed circuit comprises a USB hub IC, a USB mouse ASIC, a photo sensor IC, a display controller, a system control circuit, a USB voice controller, a voice CODEC IC, an echo killer, a function select circuit, an interface switch circuit, a USB mass storage IC, a MP3 ASIC and a multi-memory card socket connected together; and
functions of an IP phone or a hands-free IP phone conference may be proceeded, network dialog contents may be recorded, files may be accessed, and audio may be played and stored by only controlling the select switch according to the multi-function optical mouse to enhance an effectiveness of the multi-function optical mouse.

2. The multi-function optical mouse according to claim 1, further comprising a display, which is disposed on the exterior and corresponds to the display controller.

3. The multi-function optical mouse according to claim 1, further comprising a phone jack, a speaker, a mic-phone jack and a mic-phone, which are disposed on the exterior and correspond to the MP3 ASIC.

4. The multi-function optical mouse according to claim 1, further comprising a button control, which is disposed on the exterior and corresponds to the system control circuit.

5. The multi-function optical mouse according to claim 1, wherein a chip-type memory card, which may be coupled to the multi-memory card socket, comprises one of a CF memory card, a SD memory card, a MMC memory card, a RS-MMC memory card, a MS-Pro memory card, a MS-Duo memory card and a MiniSD memory card.
